(19) United States
(12) Patent Application Publication
(10) Pub. No.: US 2025/0196579 A1
(43) Pub. Date: Jun. 19, 2025

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Yong Woong Cha, Hwaseong-si (KR); Dongseok Oh, Hwaseong-si (KR); Wan Je Cho, Hwaseong-si (KR); Yeonho Kim, Hwaseong-si (KR); Jae-Eun Jeong, Hwaseong-si (KR); Jeawan Kim, Hwaseong-si (KR); Jae Yeon Kim, Hwaseong-si (KR); Seong-Bin Jeong, Hwaseong-si (KR)

(73) Assignees: HYUNDAI MOTOR COMPANY, Seoul (KR); KIA CORPORATION, Seoul (KR)

(21) Appl. No.: 18/830,171

(22) Filed: Sep. 10, 2024

(30) Foreign Application Priority Data
Dec. 13, 2023 (KR) 10-2023-0180569

(51) Int. Cl. B60H 1/00

(52) U.S. Cl. CPC B60H 1/00899

(57) ABSTRACT

A heat pump system for a vehicle may be configured to adjust a temperature of a vehicle interior by selectively exchanging heat between coolant and thermal energy generated from refrigerant at the time of condensation and evaporation. The system may use the heat-exchanged low-temperature or high-temperature coolant to improve the heating efficiency of the vehicle. The system may selectively use ambient air heat, waste heat of electrical components, and waste heat of a battery module, at the time of heating the vehicle interior. The system may increase the overall travel distance of the vehicle by efficiently adjusting the temperature of a battery module for optimal performance of the battery module.

### CROSS-REFERENCE TO RELATED APPLICATION

This application claims priority to and the benefit of Korean Patent Application No. 10-2023-0180569 filed in the Korean Intellectual Property Office on Dec. 13, 2023, the entire contents of which are incorporated herein by reference.

### BACKGROUND

### (a) Field of the Disclosure

The present disclosure relates to a heat pump system for a vehicle. More particularly, the present disclosure relates to a heat pump system for a vehicle capable of cooling or heating the vehicle interior.

### (b) Description of the Related Art

Generally, an air conditioning system for a vehicle includes an air conditioner unit circulating a refrigerant in order to heat or cool an interior of the vehicle.

The air conditioner unit, which is used to maintain the interior of the vehicle at an appropriate temperature regardless of a change in an external temperature, is configured to heat or cool the interior of the vehicle. This is achieved by heat-exchange using a condenser and an evaporator in a process in which a refrigerant discharged by driving a compressor is circulated back to the compressor through the condenser, a receiver drier, an expansion valve, and the evaporator.

In other words, the air conditioner unit lowers the temperature and humidity of the interior of the vehicle by condensing a high-temperature high-pressure gas-phase refrigerant compressed from the compressor by the condenser, passing the refrigerant through the receiver drier and the expansion valve, and then evaporating the refrigerant in the evaporator in a cooling mode.

Recently, in accordance with a continuous increased interest in energy efficiency and environmental pollution, the development of an environmentally-friendly vehicle capable of substantially substituting for an internal combustion engine vehicle is desired. Environmentally-friendly vehicles are classified into electric vehicles driven using a fuel cell or electricity as a power source and hybrid vehicles driven using an engine and a battery.

Among these environmentally-friendly vehicles, a separate heater is not used unlike an air conditioner of a typical vehicle. Additionally, an air conditioner used in the environmentally-friendly vehicles is generally called a heat pump system.

The electric vehicle driven by the power source of the fuel cell generates driving force by converting chemical reaction energy between oxygen and hydrogen into electrical energy. In this process, heat energy is generated by a chemical reaction in a fuel cell. Therefore, it is advantageous to secure performance of the fuel cell to effectively remove generated heat.

In addition, the hybrid vehicle generates driving force by driving a motor using electricity supplied from the fuel cell described above or an electrical battery, together with an engine operated by a general fuel. Therefore, heat generated from the fuel cell or the battery and the motor should be effectively removed in order to secure performance of the motor.

Therefore, in the hybrid vehicle or the electric vehicle according to the related art, a cooling means, a heat pump system, and a battery cooling system, respectively, should be configured as separate closed circuits so as to prevent heat generation of the motor, an electric component, and the battery including a fuel cell.

Therefore, the size and weight of a cooling module disposed at the front of the vehicle are increased. Also, a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain optimal performance of the battery, a plurality of valves for selectively interconnecting connections pipes are employed Thus, noise and vibration due to frequent opening and closing operations of the valves may be introduced into the vehicle interior, thereby deteriorating the ride comfort.

In addition, since a separate heat-exchanger should be employed in order to recollect the waste heat from various heat sources in the heating mode of the vehicle, there is also the disadvantage of increasing manufacturing cost.

The above information disclosed in this Background section is only to enhance understanding of the background of the disclosure. Therefore, the Background section may contain information that does not form the prior art that is already known to a person of ordinary skill in the art.

### SUMMARY

The present disclosure provides a heat pump system for a vehicle configured to adjust a temperature of a vehicle interior by selectively exchanging heat between coolant and thermal energy generated from refrigerant at the time of condensation and evaporation of the refrigerant and by using the heat-exchanged low-temperature or high-temperature coolant.

The present disclosure provides a heat pump system for a vehicle configured to improve the heating efficiency of the vehicle by selectively using ambient air heat, waste heat of electrical components, and waste heat of a battery module, at the time of heating the vehicle interior. Additionally, the system increases the overall travel distance of the vehicle by efficiently adjusting the temperature of a battery module for optimal performance of the battery module.

A heat pump system for a vehicle may include a first valve module having at least one inlet port and at least one outlet port and a second valve module having at least one inlet port and at least one outlet port The system may also include a first line having a first end and a second end connected to the first valve module to flow a coolant and provided with a radiator and an electrical component and may include a second line having a first end and a second end connected to the first valve module to flow the coolant and provided with a battery module. The system may also include a third line having a first end and a second end connected to the first valve module to flow the coolant and provided with a condenser and may include a fourth line having a first end and a second end connected to the first valve module to flow the coolant and provided with a chiller. The system may also include a fifth line having a first end and a second end connected to the second valve module to flow the coolant and connected to the condenser and may include a sixth line having a first end and a second end connected to the second valve module to flow the coolant and provided with an evaporator. The system may also include a seventh line having a first end and a second end connected to the second valve module to flow the coolant and provided with a first heat-exchanger and may include an eighth line having a first end and a second end connected to the second valve module to flow the coolant and provided with a second heat-exchanger. The first valve module and the second valve module may be configured to selectively connect the first to eighth lines based on at least one mode for temperature adjustment of a vehicle interior and temperature adjustment of the battery module, and to control a flowing movement of the coolant.

A heat pump system may further include a branch valve provided on the first line between the first valve module and the radiator and may include a branch line having a first end connected to the branch valve and having a second end connected to the first line between the radiator and the electrical component.

The at least one mode may include a first mode for cooling the vehicle interior and cooling the electrical component and the battery module, a second mode for heating the vehicle interior and recollecting ambient air heat and waste heat of the electrical component, and a third mode for heating the vehicle interior and recollecting waste heat of the electrical component and the battery module. The at least one mode may also include a fourth mode for heating the vehicle interior and heating the battery module while recollecting the waste heat of the electrical component, a fifth mode for heating the vehicle interior and recollecting the waste heat of the battery module, and a sixth mode for heating the vehicle interior by using an electric heater and recollecting residual heat of the coolant while heating the battery module.

In the first mode, the first line may be connected to the third line by an operation of the first valve module such that the coolant cooled at the radiator may be supplied to the electrical component and the condenser. The second line may be connected to the fourth line by the operation of the first valve module such that the coolant having passed through the chiller may be supplied to the battery module. Additionally, the sixth line may be connected to at least one of the seventh line and the eighth line by an operation of the second valve module, such that a low-temperature coolant having been cooled while passing through the evaporator may be supplied to one or all of the first heat-exchanger and the second heat-exchanger.

In the second mode, the first line may be connected to the fourth line by an operation of the first valve module such that the coolant having passed through the radiator and the electrical component may be supplied to the chiller. The third line may be closed by the operation of the first valve module. The fifth line may be connected to at least one of the seventh line and the eighth line by an operation of the second valve module such that the coolant whose temperature is increased while passing through the condenser may be supplied to one or all of the first heat-exchanger and the second heat-exchanger.

In the third mode, the first line, the second line, and the fourth line may be interconnected by an operation of the first valve module such that the coolant having passed through the electrical component and the battery module may be supplied to the chiller. A partial first line connecting a second end of the branch line to the radiator may be closed by an operation of the branch valve such that the coolant having passed through the electrical component may not be supplied to the radiator. The branch line may be opened by the operation of the branch valve. The third line may be closed by the operation of the first valve module. The fifth line may be connected to at least one of the seventh line and the eighth line by an operation of the second valve module, such that the coolant whose temperature is increased while passing through the condenser may be supplied into one or all of the first heat-exchanger and the second heat-exchanger.

In the fourth mode, the first line may be connected to the fourth line by an operation of the first valve module such that the coolant having passed through the electrical component may be supplied to the chiller. A partial first line connecting a second end of the branch line to the radiator may be closed by an operation of the branch valve such that the coolant having passed through the electrical component may not be supplied to the radiator. The branch line may be opened by the operation of the branch valve. The second line may be connected to the third line by the operation of the first valve module such that the coolant having passed through the condenser may be supplied to the battery module. Additionally, the fifth line may be connected to at least one of the seventh line and the eighth line by an operation of the second valve module, such that the coolant whose temperature is increased while passing through the condenser may be supplied to one or all of the first heat-exchanger and the second heat-exchanger.

In the fifth mode, the first line and the third line may be closed by an operation of the first valve module. The second line may be connected to the fourth line by the operation of the first valve module such that the coolant having passed through the battery module may be supplied to the chiller. The fifth line may be connected to at least one of the seventh line and the eighth line by an operation of the second valve module, such that the coolant whose temperature is increased while passing through the condenser may be supplied to one or all of the first heat-exchanger and the second heat-exchanger.

In the sixth mode, the first line may be closed by an operation of the first valve module. The second line, the third line, and the fourth line may be interconnected by the operation of the first valve module such that the coolant having passed through the condenser and the electric heater may sequentially pass through the battery module and the chiller. The electric heater may be operated. The fifth line may be connected to the seventh line and the eighth line by an operation of the second valve module such that the coolant whose temperature is increased while passing through the electric heater may be supplied to the first heat-exchanger and the second heat-exchanger. The battery module may increase its temperature by the coolant whose temperature is increased while passing through the electric heater. The chiller may recollect a residual heat remaining in the coolant having passed through the battery module.

When dehumidification of the vehicle interior is desired in the first mode, the fifth line may be connected to the seventh line by an operation of the second valve module such that the coolant whose temperature is increased while passing through the condenser may be supplied to the first heat-exchanger.

When dehumidification of the vehicle interior is desired in the second mode, the third mode, the fourth mode, and the fifth mode, an expanded refrigerant may be supplied to the evaporator. The sixth line may be connected to the eighth line by an operation of the second valve module such that the coolant having been cooled while passing through the evaporator may be supplied to the second heat-exchanger.

The first valve module may include: a first inlet port connected to a first end of the first line; a first outlet port connected to a second end of the first line; a second inlet port connected to a first end of the second line; a second outlet port connected to a second end of the second line; a third inlet port connected to a first end of the third line; a third outlet port connected to a second end of the third line; a fourth inlet port connected to a first end of the fourth line; and a fourth outlet port connected to the first end of the fourth line.

The second valve module may include: a first inlet port connected to a first end of the fifth line; a first outlet port connected to a second end of the fifth line; a second inlet port connected to a first end of the sixth line; a second outlet port connected to a second end of the sixth line; a third inlet port connected to a first end of the seventh line; a third outlet port connected to a second end of the seventh line; a fourth inlet port connected to a first end of the eighth line; and a fourth outlet port connected to a second end of the eighth line.

A heat pump system may further include a first water pump provided on the first line, a second water pump provided on the second line, a third water pump provided on the fifth line, and a fourth water pump provided on the sixth line.

An electric heater may be further provided at a downstream end of the condenser. The third line may be connected to the condenser and the electric heater such that the coolant may sequentially pass through the condenser and the electric heater. The fifth line may be connected to the condenser and the electric heater such that the coolant may sequentially pass through the condenser and the electric heater.

The electric heater may be integrally formed with the condenser.

An autonomous driving controller may be provided on the second line.

As described above, according to a heat pump system for a vehicle according to an embodiment, the system selectively exchanges heat between the coolant and thermal energy generated from refrigerant at the time of condensing and evaporating the refrigerant. By adjusting the temperature of the vehicle interior by using the heat-exchanged low-temperature or high-temperature coolant, the system may be streamlined and the layout of connection pipes through which refrigerant circulates may be streamlined.

In addition, according to the present disclosure, by selectively using ambient air heat, the waste heat of the electrical component, and the waste heat of the battery module, at the time of heating the vehicle interior, the heating efficiency may be improved. Additionally, the overall travel distance of the vehicle may be increased through an efficient temperature adjustment of the battery module for optimal performance of the battery module.

In addition, according to the present disclosure, when maximum cooling or heating is desired, by forming one independent closed circuit through which the coolant circulates the condenser or the evaporator, and supplying the same coolant, which may be of low temperature or high temperature, to the first heat-exchanger and second heat-exchanger, the cooling and heating performance of the vehicle interior may be improved.

In addition, according to the present disclosure, the temperature of electrical components and the battery module may be efficiently adjusted through the valve control. Accordingly, the overall marketability of the vehicle may be improved.

In addition, according to the present disclosure, due to streamlining of the entire system, it is possible to reduce the overall manufacturing cost and weight, and to improve space utilization by minimizing or reducing the number of components.

### BRIEF DESCRIPTION OF THE DRAWINGS

FIG. 1 is a block diagram of a heat pump system for a vehicle according to an embodiment.

FIG. 2 is an operation diagram according to a first mode in a heat pump system for a vehicle according to an embodiment.

FIG. 3 is an operation diagram according to a second mode in a heat pump system for a vehicle according to an embodiment.

FIG. 4 is an operation diagram according to a third mode in a heat pump system for a vehicle according to an embodiment.

FIG. 5 is an operation diagram according to a fourth mode in a heat pump system for a vehicle according to an embodiment.

FIG. 6 is an operation diagram according to a fifth mode in a heat pump system for a vehicle according to an embodiment.

FIG. 7 is an operation diagram according to a sixth mode in a heat pump system for a vehicle according to an embodiment.

### DETAILED DESCRIPTION

Embodiments are hereinafter described in detail with reference to the accompanying drawings.

The embodiments disclosed in the present specification and the constructions depicted in the drawings are only example embodiments of the present disclosure, and do not cover the entire scope of the present disclosure. Therefore, it should be understood that there may be various equivalents and variations at the time of the application of this specification.

In order to clarify the present disclosure, parts that are not related to the description have been omitted. Also, the same elements or equivalents are referred to with the same reference numerals throughout the specification.

Also, the size and thickness of each element are arbitrarily shown in the drawings and the present disclosure is not necessarily limited thereto. Additionally, in the drawings, the thickness of layers, films, panels, regions, and the like, may be exaggerated for clarity.

In addition, unless explicitly described to the contrary, the terms “comprise” and variations such as “comprises” or “comprising”, should be understood to imply the inclusion of stated elements but not the exclusion of any other elements. The same understanding should apply to similar terms such as “have,” “include”, and the like.

Furthermore, terms, such as “ . . . unit”, “ . . . means”, “ . . . portions”, “ . . . part”, and “ . . . member” described in the specification, mean a unit of a comprehensive element that performs at least one function or operation.

When a component, device, element, or the like of the present disclosure is described as having a purpose or performing an operation, function, or the like, the component, device, or element should be considered herein as being “configured to” meet that purpose or perform that operation or function.

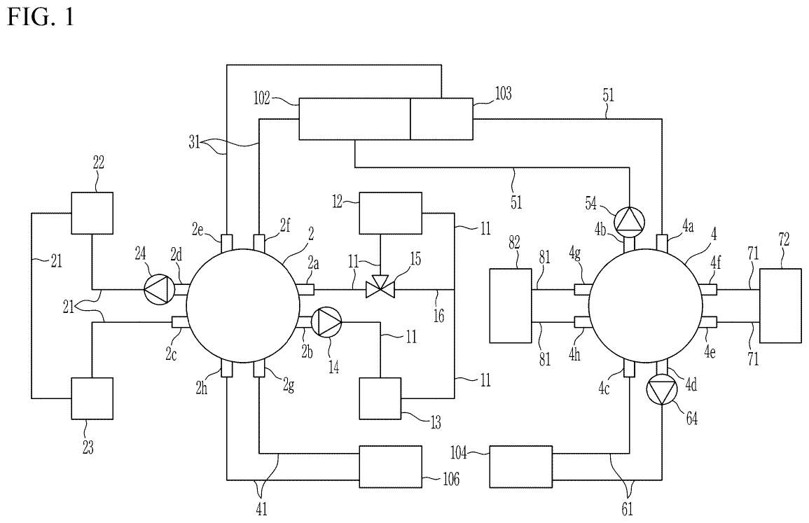

FIG. 1 is a block diagram of a heat pump system for a vehicle according to an embodiment.

A heat pump system for a vehicle according to an embodiment may selectively exchange heat between a coolant and thermal energy generated from the refrigerant at the time of condensing and evaporating a refrigerant. The heat pump system may perform cooling or heating of a vehicle interior by using a low temperature or high-temperature coolant.

In addition, for heating the vehicle interior, the heat pump system may improve heating efficiency of the vehicle by selectively using ambient air heat, waste heat of an electrical component 13, and waste heat of a battery module 22. The heat pump system may efficiently adjust the temperature of the battery module 22 for optimal performance of the battery module 22, thereby increasing the overall travel distance of the vehicle.

Such a heat pump system may be applied to a hybrid vehicle or an electric vehicle.

Referring to FIG. 1, the heat pump system may include a first valve module 2, a second valve module 4, a first line 11, a second line 21, a third line 31, a fourth line 41, a fifth line 51, a sixth line 61, a seventh line 71, and an eighth line 81.

First, the first valve module 2 may form a plurality of inlet ports and a plurality of outlet ports, and may control a flowing movement (e.g., a flow) of the introduced coolant.

The second valve module 4 may form a plurality of inlet ports and a plurality of outlet ports, and may control the flowing movement (e.g., a flow) of the introduced coolant.

In the present embodiment, the first line 11 may have a first end and a second end connected to the first valve module 2, and the coolant may flow therethrough. A radiator 12, the electrical component 13, and a first water pump 14 may be provided on the first line 11.

The radiator 12 may be disposed in the front of the vehicle, and a cooling fan may be provided at a downstream side of the radiator 12. Accordingly, the radiator 12 may cool the coolant through an operation of the cooling fan and heat-exchange with the ambient air.

The coolant cooled at the radiator 12 may circulate along the first line 11 to flow to the first valve module 2.

The electrical component 13 may include a power control apparatus, i.e., an electric power control unit (EPCU) including a motor, an on-board charger (OBC), or the like.

The power control apparatus may generate heat while the vehicle is driving and the charger may generate heat when charging the battery module 22.

In other words, at the time of heating the vehicle interior, when the waste heat of the electrical component 13 is to be recollected, the heat generated from the power control apparatus may be recollected, and the heat generated from the charger may be recollected at the time of charging the battery module 22.

The heat pump system may further include a branch valve 15 and a branch line 16.

The branch valve 15 may be provided on the first line 11 between the first valve module 2 and the radiator 12.

In addition, a first end of the branch line 16 may be connected to the branch valve 15. A second end of the branch line 16 may be connected to the first line 11 between the radiator 12 and the electrical component 13.

The branch valve 15 configured as such may selectively open the branch line 16 such that the coolant having passed through the electrical component 13 may not be introduced into the radiator 12.

In the present embodiment, the second line 21 may have a first end and a second end connected to the first valve module 2, and the coolant may flow therethrough. The battery module 22 may be provided on the second line 21.

In addition, an autonomous driving controller 23 and a second water pump 24 may be further provided on the second line 21.

The third line 31 may have a first end and a second end connected to the first valve module 2, and the coolant may flow therethrough. A condenser 102 may be provided on the third line 31.

In the present embodiment, the fourth line 41 may have a first end and a second end connected to the first valve module 2, and the coolant may flow therethrough. A chiller 106 may be provided on the fourth line 41.

The selectively expanded refrigerant may be introduced into the chiller 106. For cooling the battery module 22 and the autonomous driving controller 23, or for heating the vehicle interior, the chiller 106 may operate in order to recollect heat from the coolant whose temperature is increased by the ambient air heat, the waste heat of the electrical component 13, or the waste heat of the battery module 22.

A first end and a second end of the fifth line 51 may be connected to the second valve module, and the coolant may flow therethrough. The fifth line 51 may be connected to the condenser 102. In addition, a third water pump 54 may be provided on the fifth line 51.

In other words, the condenser 102 may be connected to the third line 31 and the fifth line 51, respectively.

The condenser 102 may be connected to a compressor (not shown) via the refrigerant line. The condenser 102 may condense the refrigerant by exchanging heat between the refrigerant and the coolant that circulates the third line 31 or the fifth line 51.

In other words, the condenser 102 may condense the introduced refrigerant through heat-exchange with the coolant, and may increase the temperature of the coolant by supplying the thermal energy generated while condensing the refrigerant to the coolant. The condenser 102 configured as such may be a water-cooled heat-exchanger into which the coolant is introduced.

An electric heater 103 may be further provided at a downstream end of the condenser 102. The electric heater 103 may be integrally formed with the condenser 102. The electric heater 103 may selectively heat the coolant introduced via the third line 31 or the fifth line 51, and thereby increase the temperature of the coolant.

Accordingly, the third line 31 may be connected to the condenser 102 and the electric heater 103 such that the coolant may sequentially pass through the condenser 102 and the electric heater 103.

In addition, the fifth line 51 may be connected to the condenser 102 and the electric heater 103 such that the coolant may sequentially pass through the condenser 102 and the electric heater 103.

In the present embodiment, the sixth line 61 may have a first end and a second end connected to the second valve module 4, and the coolant may flow therethrough. An evaporator 104 may be provided on the sixth line 61. A fourth water pump 64 may be further provided on the sixth line 61.

The evaporator 104 may be connected to an expansion valve (not shown) via the refrigerant line. The evaporator 104 may evaporate the refrigerant by exchanging heat between the refrigerant and the coolant that circulates the sixth line 61.

In other words, the evaporator 104 may evaporate the introduced refrigerant through heat-exchange with the coolant, and may lower the temperature of the coolant by supplying a low-temperature thermal energy generated by the evaporation of the refrigerant to the coolant. The evaporator 104 may be a water-cooled heat-exchanger into which the coolant is introduced.

The seventh line 71 may have a first end and a second end connected to the second valve module 4, and the coolant may flow therethrough. A first heat-exchanger 72 may be provided on the seventh line 71.

In addition, the eighth line 81 may have a first end and a second end connected to the second valve module 4, and the coolant may flow therethrough. A second heat-exchanger 82 may be provided on the eighth line 81.

The first, second, third, and fourth water pumps 14, 24, 54, and 64 may be electric water pumps.

The refrigerant may be selectively introduced into the condenser 102, the evaporator 104, and the chiller 106. Accordingly, the condenser 102, the evaporator 104, and the chiller 106 may selectively heat-exchange the thermal energy generated by condensation and evaporation of the refrigerant with the coolant flowing via the third line 31, the fourth line 41, the fifth line 51, and the sixth line 61.

In addition, the high-temperature coolant having exchanged heat at the condenser 102 and a low-temperature coolant having exchanged heat at the evaporator 104 may be supplied to at least one of the seventh line 71 and the eighth line 81 by a selective operation of the first and second valve modules 2 and 4 and the first to fourth water pumps 14, 24, 54, and 64, based on the selected mode of the vehicle.

In the present embodiment, the first heat-exchanger 72 and the second heat-exchanger 82 may be provided inside a heating, ventilation, and air-conditioning (HVAC) module (not shown).

In other words, the ambient air introduced into the vehicle interior may be converted into the high-temperature state or the low-temperature state while exchanging heat with the low-temperature or high-temperature coolant introduced into at least one of the first heat-exchanger 72 and the second heat-exchanger 82 by an operation of a blower-fan (not shown).

The ambient air at either high temperature or low temperature may be introduced into the vehicle interior, thereby cooling or heating the vehicle interior.

In the present embodiment, the first valve module 2 and the second valve module 4 may each be an 8-way valve having four inlet ports and four outlet ports. The first and second valve modules 2 and 4 are described below in more detail.

The first valve module 2 may include first, second, third, and fourth inlet ports 2a, 2c, 2e, and 2g and first, second, third, and fourth outlet ports 2b, 2d, 2f, and 2h.

First, a first end of the first line 11 may be connected to a first inlet port 2a of the first valve module 2. A second end of the first line 11 may be connected to a first outlet port 2b of the first valve module 2.

A first end of the second line 21 may be connected to a second inlet port 2c of the first valve module 2. A second end of the second line 21 may be connected to a second outlet port 2d of the first valve module 2.

A first end of the third line 31 may be connected to a third inlet port 2e of the first valve module 2. A second end of the third line 31 may be connected to a third outlet port 2f of the first valve module 2.

In addition, a first end of the fourth line 41 may be connected to a fourth inlet port 2g of the first valve module 2. A second end of the fourth line 41 may be connected to a fourth outlet port 2h of the first valve module 2.

In the present embodiment, the second valve module 4 may include first, second, third, and fourth inlet ports 4a, 4c, 4e, and 4g and first, second, third, and fourth outlet ports 4b, 4d, 4f, and 4h.

First, the first end of the fifth line 51 may be connected to a first inlet port 4a of the second valve module 4. A second end of the fifth line 51 may be connected to a first outlet port 4b of the second valve module 4.

A first end of the sixth line 61 may be connected to a second inlet port 4c of the second valve module 4. A second end of the sixth line 61 may be connected to a second outlet port 4d of the second valve module 4.

A first end of the seventh line 71 may be connected to a third inlet port 4e of the second valve module 4. A second end of the seventh line 71 may be connected to a third outlet port 4f of the second valve module 4.

In addition, a first end of the eighth line 81 may be connected to a fourth inlet port 4g of the second valve module 4. A second end of the eighth line 81 may be connected to a fourth outlet port 4h of the second valve module 4.

The present embodiment has been described as an example where the first valve module 2 or the second valve module 4 are 8-way valves having four inlet ports and four outlet ports, but is not limited thereto. The first valve module 2 or the second valve module 4 may further include more inlet ports and outlet ports such that a separate component through which the coolant circulates may be connected.

The first valve module 2 and the second valve module 4 configured as such may operate to selectively interconnect the first to eighth lines 11, 21, 31, 41, 51, 61, 71, and 81 depending on at least one mode for temperature adjustment of the vehicle interior and temperature adjustment of the battery module 22, and thereby control a flowing movement of the coolant.

The at least one mode may include a first mode to a sixth mode.

First, in the first mode, the vehicle interior and the battery module 22 may be cooled.

In the second mode, the vehicle interior may be heated, and the ambient air heat and the waste heat of the electrical component 13 may be recollected.

In the third mode, the vehicle interior may be heated, and the waste heat of the electrical component 13 and the battery module 22 may be recollected.

In the fourth mode, the vehicle interior may be heated, and the battery module 22 may be heated while recollecting the waste heat of the electrical component 13.

In the fifth mode, the vehicle interior may be heated, and the waste heat of the battery module 22 may be recollected.

In the sixth mode, the vehicle interior may be heated by using the electric heater 103, and a residual heat of the coolant may be recollected while heating the battery module 22.

When dehumidification of the vehicle interior is desired in the first mode, the fifth line 51 may be connected to the seventh line 71 by an operation of the second valve module 4 such that the coolant whose temperature is increased while passing through the condenser 102 may be introduced into the first heat-exchanger 72.

In addition, when dehumidification of the vehicle interior is desired in the second mode, the third mode, the fourth mode, and the fifth mode, the expanded refrigerant may be supplied to the evaporator 104, and the sixth line 61 may be connected to the eighth line 81 by the operation of the second valve module 4. Thus, the coolant having been cooled while passing through the evaporator 104 may be introduced into the second heat-exchanger 82.

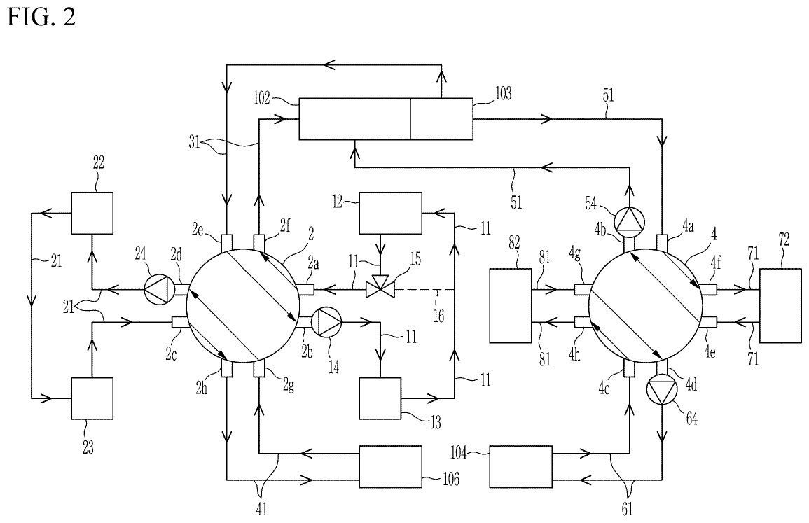

Hereinafter, an operation and action for each mode of a heat pump system for a vehicle according to an embodiment configured as described above is described in detail with reference to FIGS. 2-7.

First, in a heat pump system for a vehicle according to an embodiment, the operation according to the first mode for cooling the vehicle interior and cooling the battery module 22 is described with reference to FIG. 2.

FIG. 2 is an operation diagram according to the first mode in a heat pump system for a vehicle according to an embodiment.

Referring to FIG. 2, the refrigerant may circulate through the condenser 102, the evaporator 104, and the chiller 106. At this time, the expanded refrigerant may be supplied to each of the evaporator 104 and the chiller 106.

In addition, the first line 11 may be connected to the third line 31 by an operation of the first valve module 2 such that the coolant cooled at the radiator 12 may be introduced into the electrical component 13 and the condenser 102.

The branch line 16 may be closed by an operation of the branch valve 15.

Accordingly, the coolant cooled at the radiator 12 may be introduced into the first inlet port 2a of the first valve module 2 along the first line 11 by an operation of the first water pump 14.

The coolant introduced into the first inlet port 2a of the first valve module 2 may be discharged to the third line 31 connected to the third outlet port 2f of the first valve module 2 by the operation of the first valve module 2.

The coolant discharged to the third line 31 may sequentially pass through the condenser 102 and the electric heater 103. The condenser 102 may condense the refrigerant by using the coolant flowing along the third line 31.

Then, the coolant having passed through the condenser 102 and the electric heater 103 may be introduced into the third inlet port 2e of the first valve module 2 along the third line 31.

The coolant introduced into the third inlet port 2e of the first valve module 2 may be discharged to the first outlet port 2b of the first valve module 2, and supplied to the electrical component 13 along the first line 11.

Accordingly, the electrical component 13 may be efficiently cooled by the coolant cooled at the radiator 12.

In other words, in the first mode, the first line 11 and the third line 31 may form one closed circuit through which the coolant circulates by the operation of the first valve module 2.

In such a state, the coolant may circulate along the first line 11 and the third line 31 interconnected by the operation of the first water pump 14.

The second line 21 may be connected to the fourth line 41 by the operation of the first valve module 2 such that the coolant cooled through heat-exchange with the refrigerant while passing through the chiller 106 may be supplied to the battery module 22 and the autonomous driving controller 23.

In other words, the coolant introduced from the chiller 106 into the fourth inlet port 2g of the first valve module 2 along the fourth line 41 may be discharged to the second line 21 connected to the second outlet port 2d of the first valve module 2 by the operation of the first valve module 2.

The coolant discharged to the second line 21 may pass through the battery module 22 and the autonomous driving controller 23 and then may be introduced into the second inlet port 2c of the first valve module 2 along the second line 21.

Then, the coolant introduced into the second inlet port 2c of the first valve module 2 may be discharged to the fourth line 41 connected to the fourth outlet port 2h of the first valve module 2 by the operation of the first valve module 2.

The coolant discharged to the fourth line 41 may pass through the chiller 106, and then may be introduced back into the fourth inlet port 2g of the first valve module 2.

In other words, in the first mode, the second line 21 and the fourth line 41 may form another closed circuit through which the coolant circulates by the operation of the first valve module 2.

In such a state, the coolant may circulate along the second line 21 and the fourth line 41 interconnected by an operation of the second water pump 24.

At this time, the chiller 106 may cool the coolant by exchanging heat between the coolant introduced via the fourth line 41 and the refrigerant.

Therefore, the coolant cooled at the chiller 106 may efficiently cool the battery module 22 and the autonomous driving controller 23 while circulating via the second line 21 and the fourth line 41 interconnected with each other.

In addition, the sixth line 61 may be connected to the eighth line 81 by the operation of the second valve module 4 such that the low-temperature coolant having been cooled while passing through the evaporator 104 may be introduced into the second heat-exchanger 82.

In other words, the sixth line 61 and the eighth line 81 may form an independent closed circuit by the operation of the second valve module 4.

The evaporator 104 may cool the coolant circulating along the sixth line 61 through heat-exchange with a low-temperature refrigerant, and may evaporate the refrigerant.

Accordingly, the low-temperature coolant cooled while passing through the evaporator 104 may be introduced into the second inlet port 4c of the second valve module 4 along the sixth line 61 by an operation of the fourth water pump 64.

The coolant introduced into the second inlet port 4c of the second valve module 4 may be discharged to the eighth line 81 connected to the fourth outlet port 4h of the second valve module 4 by the operation of the second valve module 4.

The coolant flowing along the eighth line 81 may pass through the second heat-exchanger 82 and then may be introduced into the fourth inlet port 4g of the second valve module 4.

The coolant introduced into the fourth inlet port 4g of the second valve module 4 may be discharged to the sixth line 61 connected to the second outlet port 4d of the second valve module 4 by the operation of the second valve module 4.

In other words, the coolant may circulate along the sixth line 61 and the eighth line 81 by an operation of the second valve module 4 and the fourth water pump 64.

Accordingly, the low-temperature coolant cooled at the evaporator 104 may circulate along the sixth line 61 and the eighth line 81 by the operation of the fourth water pump 64 and second valve module 4, and thereby, be supplied to the second heat-exchanger 82.

In such a state, the ambient air introduced into the vehicle interior may be cooled while having exchanged heat with the low-temperature coolant supplied to the second heat-exchanger 82 by the operation of the blower-fan (not shown). Thereafter, the cooled ambient air may be directly introduced into the vehicle interior, thereby efficiently cooling the vehicle interior.

The present embodiment has been described that, for cooling the vehicle interior, the coolant cooled at the evaporator 104 may flow into the second heat-exchanger 82 along the sixth line 61 and the eighth line 81, but is not limited thereto.

In other words, when the maximum cooling of the vehicle interior is desired, the sixth line 61, the seventh line 71, and the eighth line 81 may be interconnected by the operation of the second valve module 4.

In such a state, when the fourth water pump 64 is operated, the coolant cooled at the evaporator 104 may be supplied to both of the first heat-exchanger 72 and the second heat-exchanger 82 while circulating along the sixth line 61, the seventh line 71, and the eighth line 81.

In addition, when dehumidification is desired while cooling the vehicle interior, the fifth line 51 may be connected to the seventh line 71 by the operation of the second valve module 4.

Accordingly, the fifth line 51 and the seventh line 71 may form one closed circuit through which the coolant circulates by the operation of the second valve module 4. Then, the coolant may circulate along the fifth line 51 and the seventh line 71 interconnected by an operation of the third water pump 54.

In other words, the coolant discharged to the first outlet port 4b of the second valve module 4 may pass through the condenser 102 and the electric heater 103.

At this time, the condenser 102 may condense the introduced refrigerant through heat-exchange with the coolant. The temperature of the coolant may be increased while condensing the refrigerant at the condenser 102.

The coolant whose temperature is increased may be introduced into the first inlet port 4a of the second valve module 4 along the fifth line 51. Thereafter, the coolant introduced into the first inlet port 4a of the second valve module 4 may be discharged to the seventh line 71 connected to the third outlet port 4f of the second valve module 4 by the operation of the second valve module 4.

The coolant discharged to the seventh line 71 may pass through the first heat-exchanger 72 and then may be introduced back into the third inlet port 4e of the second valve module 4 along the seventh line 71.

In addition, the coolant introduced into the third inlet port 4e of the second valve module 4 may be discharged again to the first outlet port 4b of the second valve module 4 by the operation of the second valve module 4.

In other words, the coolant whose temperature is increased at the condenser 102 by such an operation may be introduced into the first heat-exchanger 72.

Accordingly, the ambient air introduced into the vehicle interior may be cooled while having exchanged heat with the low-temperature coolant supplied to the second heat-exchanger 82 by the operation of the blower-fan (not shown). Thereafter, the cooled ambient air may be dehumidified while passing through the first heat-exchanger 72 and introduced into the vehicle interior, thereby smoothly cooling and dehumidifying the vehicle interior.

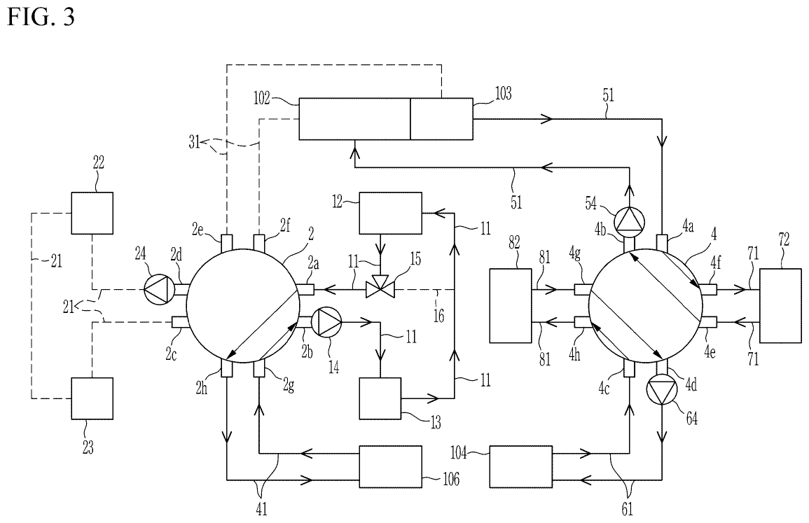

In a heat pump system for a vehicle according to an embodiment, the operation according to the second mode for heating the vehicle interior and recollecting the ambient air heat and the waste heat of the electrical component 13 is described with reference to FIG. 3.

FIG. 3 is an operation diagram according to the second mode in a heat pump system for a vehicle according to an embodiment.

Referring to FIG. 3, the refrigerant may circulate through the condenser 102 and the chiller 106. At this time, the expanded refrigerant may be supplied to the chiller 106.

In addition, the first line 11 may be connected to the fourth line 41 by the operation of the first valve module 2 such that the coolant having passed through the radiator 12 and the electrical component 13 may be introduced into the chiller 106.

The branch line 16 may be closed by the operation of the branch valve 15.

In addition, the second line 21 and the third line 31 may be closed by the operation of the first valve module 2.

Accordingly, the coolant may recollect the ambient air heat through heat-exchange with the ambient air while passing through the radiator 12, and may absorb the waste heat from the electrical component 13 to increase its temperature.

The coolant whose temperature is increased may be introduced into the first inlet port 2a of the first valve module 2 along the first line 11 by the operation of the first water pump 14.

The coolant introduced into the first inlet port 2a of the first valve module 2 may be discharged to the fourth line 41 connected to the fourth outlet port 2h of the first valve module 2 by the operation of the first valve module 2.

The coolant discharged to the fourth line 41 may be supplied to the chiller 106. Therefore, the ambient air heat recollected at the radiator 12 and the waste heat generated at the electrical component 13 may increase the temperature of the refrigerant supplied to the chiller 106.

In other words, the chiller 106 may be used to increase the temperature of the refrigerant by recollecting the ambient air heat and the waste heat of the electrical component 13 through heat-exchange between the coolant and the refrigerant.

Then, the coolant having passed through the chiller 106 may be introduced into the fourth inlet port 2g of the first valve module 2 along the fourth line 41.

The coolant introduced into the fourth inlet port 2g of the first valve module 2 may be discharged to the first line 11 connected to the first outlet port 2b of the first valve module 2 by the operation of the first valve module 2.

The coolant discharged to the first line 11 may sequentially pass through the electrical component 13 and the radiator 12, and then flow back into the first valve module 2, thereby repeatedly performing the above-described processes.

In other words, in the second mode, the first line 11 and the fourth line 41 may form one closed circuit through which the coolant circulates by the operation of the first valve module 2.

In such a state, the coolant may circulate along the first line 11 and the fourth line 41 interconnected by the operation of the first water pump 14.

Simultaneously, the fifth line 51 may be connected to the seventh line 71 by the operation of the second valve module 4 such that the coolant whose temperature is increased while passing through the condenser 102 may be introduced into the first heat-exchanger 72.

Accordingly, the fifth line 51 and the seventh line 71 may form one closed circuit through which the coolant circulates by the operation of the second valve module 4. Then, the coolant may circulate along the fifth line 51 and the seventh line 71 interconnected by the operation of the third water pump 54.

In other words, the coolant discharged to the first outlet port 4b of the second valve module 4 may pass through the condenser 102 and the electric heater 103.

At this time, the condenser 102 may condense the introduced refrigerant through heat-exchange with the coolant. The temperature of the coolant may be increased while condensing the refrigerant at the condenser 102.

The coolant whose temperature is increased may be introduced into the first inlet port 4a of the second valve module 4 along the fifth line 51. Thereafter, the coolant introduced into the first inlet port 4a of the second valve module 4 may be discharged to the seventh line 71 connected to the third outlet port 4f of the second valve module 4 by the operation of the second valve module 4.

The coolant discharged to the seventh line 71 may pass through the first heat-exchanger 72 and then may be introduced back into the third inlet port 4e of the second valve module 4 along the seventh line 71.

In addition, the coolant introduced into the third inlet port 4e of the second valve module 4 may be discharged again to the first outlet port 4b of the second valve module 4 by the operation of the second valve module 4.

In other words, the coolant whose temperature is increased at the condenser 102 by such an operation may be introduced into the first heat-exchanger 72.

In such a state, the ambient air introduced into the vehicle interior may be converted into the high-temperature state while having exchanged heat with the high-temperature coolant supplied to the first heat-exchanger 72 by the operation of the blower-fan (not shown). Thereafter, the ambient air in the high-temperature state may be introduced into the vehicle interior, thereby achieving heating of the vehicle interior.

In other words, according to a heat pump system according to the present embodiment, for heating the vehicle interior, by absorbing the ambient air heat and the waste heat of the electrical component 13 by the chiller 106 and using it to increase the temperature of the refrigerant, the power consumption of the compressor may be reduced and the heating efficiency may be improved.

The present embodiment has been described that, for heating the vehicle interior, the coolant whose temperature is increased at the condenser 102 may flow into the first heat-exchanger 72 along the fifth line 51 and the seventh line 71, but is not limited thereto.

In other words, when maximum heating of the vehicle interior is desired, the fifth line 51, the seventh line 71, and the eighth line 81 may be interconnected by the operation of the second valve module 4.

In such a state, when the third water pump 54 is operated, the coolant whose temperature is increased at the condenser 102 may be supplied to both of the first heat-exchanger 72 and the second heat-exchanger 82 while circulating along the fifth line 51, the seventh line 71, and the eighth line 81.

In addition, when dehumidification is desired while heating the vehicle interior, the expanded refrigerant may be supplied to the evaporator 104. The sixth line 61 may be connected to the eighth line 81 by the operation of the second valve module 4.

Accordingly, the sixth line 61 and the eighth line 81 may form one closed circuit through which the coolant circulates by the operation of the second valve module 4. Then, the coolant may circulate along the sixth line 61 and the eighth line 81 interconnected by the operation of the fourth water pump 64.

Accordingly, the low-temperature coolant cooled at the evaporator 104 may circulate along the sixth line 61 and the eighth line 81 by the operation of the fourth water pump 64 and second valve module 4, and thereby, be supplied to the second heat-exchanger 82.

Accordingly, the ambient air introduced into the vehicle interior may be dehumidified while having exchanged heat with the low-temperature coolant supplied to the second heat-exchanger 82 by the operation of the blower-fan (not shown).

Then, the dehumidified ambient air may be converted into the high-temperature state while passing through the first heat-exchanger 72 and then introduced into the vehicle interior, thereby smoothly heating and dehumidifying the vehicle interior.

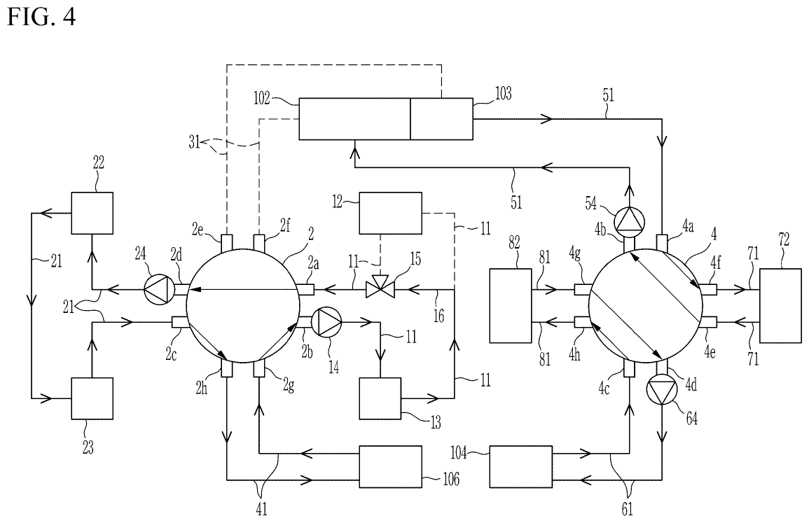

In a heat pump system for a vehicle according to an embodiment, the operation according to the third mode for heating the vehicle interior and recollecting the waste heat of the electrical component 13 and the battery module 22 is described with reference to FIG. 4.

FIG. 4 is an operation diagram according to the third mode in a heat pump system for a vehicle according to an embodiment.

Referring to FIG. 4, the refrigerant may circulate through the condenser 102 and the chiller 106. At this time, the expanded refrigerant may be supplied to the chiller 106.

In addition, the first line 11, the second line 21, and the fourth line 41 may be interconnected by the operation of the first valve module 2 such that the coolant having passed through the electrical component 13 and the battery module 22 may be introduced into the chiller 106.

A partial first line 11 connecting from the second end of the branch line 16 to the radiator 12 may be closed by the operation of the branch valve 15, such that the coolant having passed through the electrical component 13 may not be introduced into the radiator 12.

Simultaneously, the branch line 16 may be opened by the operation of the branch valve 15.

In addition, the third line 31 may be closed by the operation of the first valve module 2.

Accordingly, the coolant may absorb the waste heat from the electrical component 13 while passing through the electrical component 13 along the opened first line 11 by the operation of the first water pump 14, and thereby may increase its temperature.

The coolant whose temperature is increased may be introduced into the branch valve 15 via the opened branch line 16 and then may be introduced into the first inlet port 2a of the first valve module 2 along the first line 11 connected to the branch valve 15.

The coolant introduced into the first inlet port 2a of the first valve module 2 may be discharged to the second line 21 connected to the second outlet port 2d of the first valve module 2 by the operation of the first valve module 2.

The coolant discharged to the second line 21 may pass through the battery module 22 and the autonomous driving controller 23 by the operation of the second water pump 24 and then may be introduced into the second inlet port 2c of the first valve module 2 along the second line 21.

The coolant may absorb waste heat from the battery module 22 while passing through the battery module 22, thereby further increasing its temperature.

Then, the coolant introduced into the second inlet port 2c of the first valve module 2 may be discharged to the fourth line 41 connected to the fourth outlet port 2h of the first valve module 2 by the operation of the first valve module 2.

The coolant discharged to the fourth line 41 may be supplied to the chiller 106. Therefore, the waste heat generated at the electrical component 13 and the waste heat generated at the battery module 22 may increase the temperature of the refrigerant supplied to the chiller 106.

In other words, the chiller 106 may be used to increase the temperature of the refrigerant by recollecting the waste heat of the electrical component 13 and the battery module 22 through heat-exchange between the coolant and the refrigerant.

Then, the coolant having passed through the chiller 106 may be introduced into the fourth inlet port 2g of the first valve module 2 along the fourth line 41.

The coolant introduced into the fourth inlet port 2g of the first valve module 2 may be discharged to the first line 11 connected to the first outlet port 2b of the first valve module 2 by the operation of the first valve module 2.

The coolant discharged to the first line 11 may pass through the electrical component 13 and then flow back into the first valve module 2 along the branch line 16 and the first line 11, thereby repeatedly performing the above-described processes.

In other words, in the third mode, the first line 11, the second line 21, and the fourth line 41 may form one closed circuit through which the coolant circulates by the operation of the first valve module 2.

In such a state, the coolant may circulate along the first line 11, the second line 21, and the fourth line 41 that are interconnected by an operation of the first water pump 14 and the second water pump 24.

Simultaneously, the fifth line 51 may be connected to the seventh line 71 by the operation of the second valve module 4 such that the coolant whose temperature is increased while passing through the condenser 102 may be introduced into the first heat-exchanger 72.

Accordingly, the fifth line 51 and the seventh line 71 may form one closed circuit through which the coolant circulates by the operation of the second valve module 4. Then, the coolant may circulate along the fifth line 51 and the seventh line 71 interconnected by the operation of the third water pump 54.

In other words, the coolant discharged to the first outlet port 4b of the second valve module 4 may pass through the condenser 102 and the electric heater 103.

At this time, the condenser 102 may condense the introduced refrigerant through heat-exchange with the coolant. The temperature of the coolant may be increased while condensing the refrigerant at the condenser 102.

The coolant whose temperature is increased may be introduced into the first inlet port 4a of the second valve module 4 along the fifth line 51. Thereafter, the coolant introduced into the first inlet port 4a of the second valve module 4 may be discharged to the seventh line 71 connected to the third outlet port 4f of the second valve module 4 by the operation of the second valve module 4.

The coolant discharged to the seventh line 71 may pass through the first heat-exchanger 72 and then may be introduced back into the third inlet port 4e of the second valve module 4 along the seventh line 71.

In addition, the coolant introduced into the third inlet port 4e of the second valve module 4 may be discharged again to the first outlet port 4b of the second valve module 4 by the operation of the second valve module 4.

In other words, the coolant whose temperature is increased at the condenser 102 by such an operation may be introduced into the first heat-exchanger 72.

In such a state, the ambient air introduced into the vehicle interior may be converted into the high-temperature state while being heat-exchanged with the high-temperature coolant supplied to the first heat-exchanger 72 by the operation of the blower-fan (not shown). Thereafter, the ambient air in the high-temperature state may be introduced into the vehicle interior, thereby achieving heating of the vehicle interior.

In other words, according to a heat pump system according to the present embodiment, for heating the vehicle interior, by absorbing the waste heat of the electrical component 13 and the waste heat of the battery module 22 by the chiller 106 and using it to increase the temperature of the refrigerant, the power consumption of the compressor may be reduced and the heating efficiency may be improved.

The present embodiment has been described that, for heating the vehicle interior, the coolant whose temperature is increased at the condenser 102 may flow into the first heat-exchanger 72 along the fifth line 51 and the seventh line 71, but is not limited thereto.

In other words, when a maximum heating of the vehicle interior is desired, the fifth line 51, the seventh line 71, and the eighth line 81 may be interconnected by the operation of the second valve module 4.

In such a state, when the third water pump 54 is operated, the coolant whose temperature is increased at the condenser 102 may be supplied to both of the first heat-exchanger 72 and the second heat-exchanger 82 while circulating along the fifth line 51, the seventh line 71, and the eighth line 81.

In addition, when dehumidification is desired while heating the vehicle interior, the expanded refrigerant may be supplied to the evaporator 104. The sixth line 61 may be connected to the eighth line 81 by the operation of the second valve module 4.

Accordingly, the sixth line 61 and the eighth line 81 may form one closed circuit through which the coolant circulates by the operation of the second valve module 4. Then, the coolant may circulate along the sixth line 61 and the eighth line 81 interconnected by the operation of the fourth water pump 64.

Accordingly, the low-temperature coolant cooled at the evaporator 104 may circulate along the sixth line 61 and the eighth line 81 by the operation of the fourth water pump 64 and second valve module 4, and thereby, be supplied to the second heat-exchanger 82.

Accordingly, the ambient air introduced into the vehicle interior may be dehumidified while having exchanged heat with the low-temperature coolant supplied to the second heat-exchanger 82 by the operation of the blower-fan (not shown).

Then, the dehumidified ambient air may be converted into the high-temperature state while passing through the first heat-exchanger 72 and then introduced into the vehicle interior, thereby smoothly heating and dehumidifying the vehicle interior.

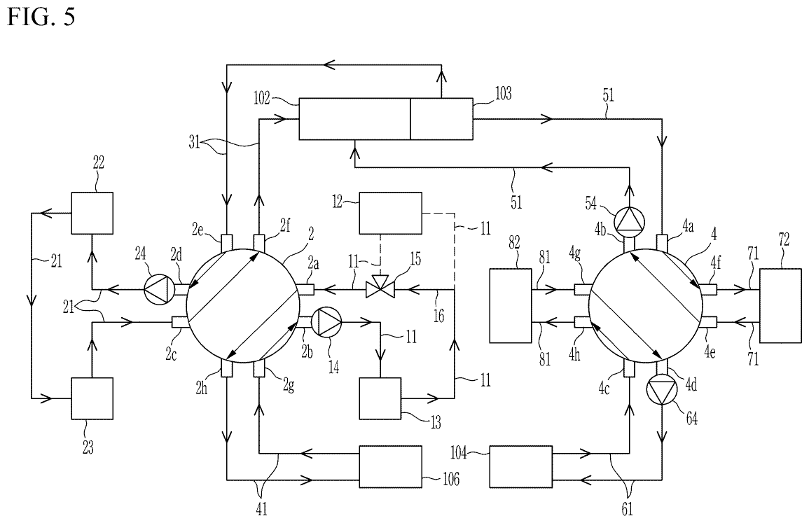

In a heat pump system for a vehicle according to an embodiment, the operation according to the fourth mode for heating the vehicle interior and heating the battery module 22 while recollecting the waste heat of the electrical component 13 is described with reference to FIG. 5.

FIG. 5 is an operation diagram according to the fourth mode in a heat pump system for a vehicle according to an embodiment.

Referring to FIG. 5, the refrigerant may circulate through the condenser 102 and the chiller 106. At this time, the expanded refrigerant may be supplied to the chiller 106.

In addition, the first line 11 may be connected to the fourth line 41 by the operation of the first valve module 2 such that the coolant having passed through the electrical component 13 may be introduced into the chiller 106.

The partial first line 11 connecting from the second end of the branch line 16 to the radiator 12 may be closed by the operation of the branch valve 15. Thus, the coolant having passed through the electrical component 13 may not be introduced into the radiator 12.

Simultaneously, the branch line 16 may be opened by the operation of the branch valve 15.

Accordingly, the coolant may absorb the waste heat from the electrical component 13 while passing through the electrical component 13 along the opened first line 11 by the operation of the first water pump 14, and thereby may increase its temperature.

The coolant whose temperature is increased may be introduced into the branch valve 15 via the opened branch line 16 and then may be introduced into the first inlet port 2a of the first valve module 2 along the first line 11 connected to the branch valve 15.

The coolant introduced into the first inlet port 2a of the first valve module 2 may be discharged to the fourth line 41 connected to the fourth outlet port 2h of the first valve module 2 by the operation of the first valve module 2.

The coolant discharged to the fourth line 41 may be supplied to the chiller 106. Therefore, the waste heat generated at the electrical component 13 may increase the temperature of the refrigerant supplied to the chiller 106.

In other words, the chiller 106 may be used to increase the temperature of the refrigerant by recollecting the waste heat of the electrical component 13 through heat-exchange between the coolant and the refrigerant.

Then, the coolant having passed through the chiller 106 may be introduced into the fourth inlet port 2g of the first valve module 2 along the fourth line 41.

The coolant introduced into the fourth inlet port 2g of the first valve module 2 may be discharged to the first line 11 connected to the first outlet port 2b of the first valve module 2 by the operation of the first valve module 2.

The coolant discharged to the first line 11 may pass through the electrical component 13 and then flow back into the first valve module 2, thereby repeatedly performing the above-described processes.

In other words, in the fourth mode, the first line 11 and the fourth line 41 may form one closed circuit through which the coolant circulates by the operation of the first valve module 2.

In such a state, the coolant may circulate along the first line 11 and the fourth line 41 interconnected by the operation of the first water pump 14.

Simultaneously, the second line 21 may be connected to the third line 31 by the operation of the first valve module 2 such that the coolant whose temperature is increased while passing through the condenser 102 may be introduced into the battery module 22.

Accordingly, the coolant having passed through the battery module 22 and the autonomous driving controller 23 by the operation of the second water pump 24 may be introduced into the second inlet port 2c of the first valve module 2 along the second line 21.

Then, the coolant introduced into the second inlet port 2c of the first valve module 2 may be discharged to the third line 31 connected to the third outlet port 2f of the first valve module 2 by the operation of the first valve module 2.

The coolant discharged to the third line 31 may sequentially pass through the condenser 102 and the electric heater 103. The condenser 102 may condense the refrigerant by using the coolant flowing along the third line 31.

At this time, the temperature of the coolant may be increased while condensing the refrigerant at the condenser 102. The coolant whose temperature is increased while passing through the condenser 102 may flow along the third line 31, and may be introduced into the third inlet port 2e of the first valve module 2.

The coolant introduced into the third inlet port 2e of the first valve module 2 may be discharged to the second line 21 connected to the second outlet port 2d of the first valve module 2 by the operation of the first valve module 2.

The coolant discharged to the second line 21 may increase the temperature of the battery module 22 while passing through the battery module 22.

In other words, through such an operation, the battery module 22 may efficiently increase its temperature as the coolant whose temperature is increased is supplied.

As such, in the fourth mode, the second line 21 and the third line 31 may form one closed circuit through which the coolant circulates by the operation of the first valve module 2.

In such a state, the coolant may circulate along the second line 21 and the third line 31 interconnected by the operation of the second water pump 24.

The fifth line 51 may be connected to the seventh line 71 by the operation of the second valve module 4 such that the coolant whose temperature is increased while passing through the condenser 102 may be introduced into the first heat-exchanger 72.

Accordingly, the fifth line 51 and the seventh line 71 may form one closed circuit through which the coolant circulates by the operation of the second valve module 4. Then, the coolant may circulate along the fifth line 51 and the seventh line 71 interconnected by the operation of the third water pump 54.

In other words, the coolant discharged to the first outlet port 4b of the second valve module 4 may pass through the condenser 102 and the electric heater 103.

At this time, the condenser 102 may condense the introduced refrigerant through heat-exchange with the coolant. The temperature of the coolant may be increased while condensing the refrigerant at the condenser 102.

The coolant whose temperature is increased may be introduced into the first inlet port 4a of the second valve module 4 along the fifth line 51. Thereafter, the coolant introduced into the first inlet port 4a of the second valve module 4 may be discharged to the seventh line 71 connected to the third outlet port 4f of the second valve module 4 by the operation of the second valve module 4.

The coolant discharged to the seventh line 71 may pass through the first heat-exchanger 72 and then may be introduced back into the third inlet port 4e of the second valve module 4 along the seventh line 71.

In addition, the coolant introduced into the third inlet port 4e of the second valve module 4 may be discharged again to the first outlet port 4b of the second valve module 4 by the operation of the second valve module 4.

In other words, the coolant whose temperature is increased at the condenser 102 by such an operation may be introduced into the first heat-exchanger 72.

In such a state, the ambient air introduced into the vehicle interior may be converted into the high-temperature state while having exchanged heat with the high-temperature coolant supplied to the first heat-exchanger 72 by the operation of the blower-fan (not shown). Thereafter, the ambient air in the high-temperature state may be introduced into the vehicle interior, thereby achieving heating of the vehicle interior.

In other words, according to a heat pump system according to the present embodiment, for heating the vehicle interior, by absorbing the waste heat of the electrical component 13 by the chiller 106 and using it to increase the temperature of the refrigerant, the power consumption of the compressor may be reduced and the heating efficiency may be improved.

In addition, when heating of the battery module 22 is desired, the heat pump system may supply the coolant whose temperature is increased while passing through the condenser 102 to the battery module 22, thereby efficiently increasing the temperature of the battery module 22.

The present embodiment has been described that, for heating the vehicle interior, the coolant whose temperature is increased at the condenser 102 may flow into the first heat-exchanger 72 along the fifth line 51 and the seventh line 71, but is not limited thereto.

In other words, when maximum heating of the vehicle interior is desired, the fifth line 51, the seventh line 71, and the eighth line 81 may be interconnected by the operation of the second valve module 4.

In such a state, when the third water pump 54 is operated, the coolant whose temperature is increased at the condenser 102 may be supplied to both of the first heat-exchanger 72 and the second heat-exchanger 82 while circulating along the fifth line 51, the seventh line 71, and the eighth line 81.

In addition, when dehumidification is desired while heating the vehicle interior, the expanded refrigerant may be supplied to the evaporator 104. The sixth line 61 may be connected to the eighth line 81 by the operation of the second valve module 4.

Accordingly, the sixth line 61 and the eighth line 81 may form one closed circuit through which the coolant circulates by the operation of the second valve module 4. Then, the coolant may circulate along the sixth line 61 and the eighth line 81 interconnected by the operation of the fourth water pump 64.

Accordingly, the low-temperature coolant cooled at the evaporator 104 may circulate along the sixth line 61 and the eighth line 81 by the operation of the fourth water pump 64 and second valve module 4, and thereby, be supplied to the second heat-exchanger 82.

Accordingly, the ambient air introduced into the vehicle interior may be dehumidified while having exchanged heat with the low-temperature coolant supplied to the second heat-exchanger 82 by the operation of the blower-fan (not shown).

Then, the dehumidified ambient air may be converted into the high-temperature state while passing through the first heat-exchanger 72 and then introduced into the vehicle interior, thereby smoothly heating and dehumidifying the vehicle interior.

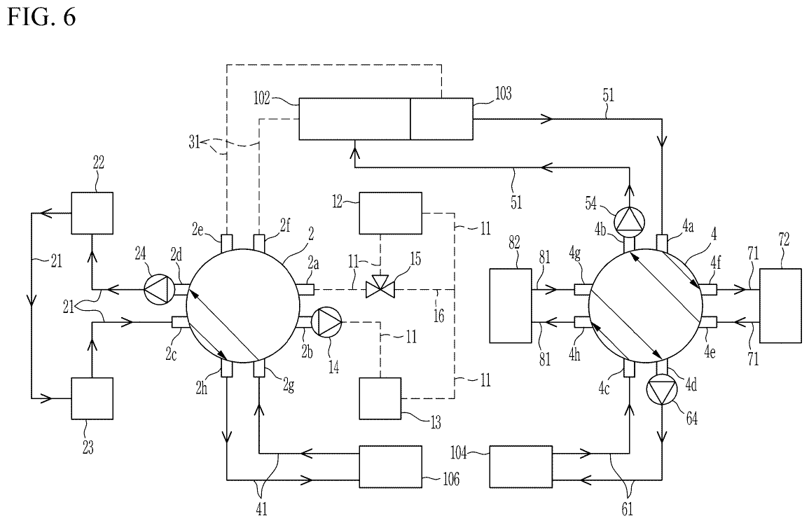

In a heat pump system for a vehicle according to an embodiment, the operation according to the fifth mode for heating the vehicle interior and recollecting the waste heat of the battery module 22 is described with reference to FIG. 6.

FIG. 6 is an operation diagram based on the fifth mode in a heat pump system for a vehicle according to an embodiment.

Referring to FIG. 6, the refrigerant may circulate through the condenser 102 and the chiller 106. At this time, the expanded refrigerant may be supplied to the chiller 106.

The first line 11 and the third line 31 may be closed by the operation of the first valve module 2. At the same time, the branch line 16 may be closed by the operation of the branch valve 15.

In addition, the second line 21 may be connected to the fourth line 41 by the operation of the first valve module 2 such that the coolant having passed through the battery module 22 may be introduced into the chiller 106.

In addition, the third line 31 may be closed by the operation of the first valve module 2.

Accordingly, the coolant may absorb waste heat from the battery module 22 while passing through the battery module 22 and the autonomous driving controller 23 along the second line 21 by the operation of the second water pump 24, thereby increasing its temperature.

The coolant whose temperature is increased may be introduced into the second inlet port 2c of the first valve module 2 along the second line 21.

The coolant introduced into the second inlet port 2c of the first valve module 2 may be discharged to the fourth line 41 connected to the fourth outlet port 2h of the first valve module 2 by the operation of the first valve module 2.

The coolant discharged to the fourth line 41 may be supplied to the chiller 106. Therefore, the waste heat generated at the battery module 22 may increase the temperature of the refrigerant supplied to the chiller 106.

In other words, the chiller 106 may be used to increase the temperature of the refrigerant by recollecting the waste heat of the battery module 22 through heat-exchange between the coolant and the refrigerant.

Then, the coolant having passed through the chiller 106 may be introduced into the fourth inlet port 2g of the first valve module 2 along the fourth line 41.

The coolant introduced into the fourth inlet port 2g of the first valve module 2 may be discharged to the second line 21 connected to the second outlet port 2d of the first valve module 2 by the operation of the first valve module 2.

The coolant discharged to the second line 21 may pass through the battery module 22 and then flow back into the first valve module 2 along the second line 21, thereby repeatedly performing the above-described processes.

In other words, in the fifth mode, the second line 21 and the fourth line 41 may form one closed circuit through which the coolant circulates by the operation of the first valve module 2.

In such a state, the coolant may circulate along the second line 21 and the fourth line 41 interconnected by the operation of the second water pump 24.

Simultaneously, the fifth line 51 may be connected to the seventh line 71 by the operation of the second valve module 4 such that the coolant whose temperature is increased while passing through the condenser 102 may be introduced into the first heat-exchanger 72.

Accordingly, the fifth line 51 and the seventh line 71 may form one closed circuit through which the coolant circulates by the operation of the second valve module 4. Then, the coolant may circulate along the fifth line 51 and the seventh line 71 interconnected by the operation of the third water pump 54.

In other words, the coolant discharged to the first outlet port 4b of the second valve module 4 may pass through the condenser 102 and the electric heater 103.

At this time, the condenser 102 may condense the introduced refrigerant through heat-exchange with the coolant. The temperature of the coolant may be increased while condensing the refrigerant at the condenser 102.

The coolant whose temperature is increased may be introduced into the first inlet port 4a of the second valve module 4 along the fifth line 51. Thereafter, the coolant introduced into the first inlet port 4a of the second valve module 4 may be discharged to the seventh line 71 connected to the third outlet port 4f of the second valve module 4 by the operation of the second valve module 4.

The coolant discharged to the seventh line 71 may pass through the first heat-exchanger 72 and then may be introduced back into the third inlet port 4e of the second valve module 4 along the seventh line 71.

In addition, the coolant introduced into the third inlet port 4e of the second valve module 4 may be discharged again to the first outlet port 4b of the second valve module 4 by the operation of the second valve module 4.

In other words, the coolant whose temperature is increased at the condenser 102 by such an operation may be introduced into the first heat-exchanger 72.

In such a state, the ambient air introduced into the vehicle interior may be converted into the high-temperature state while being heat-exchanged with the high-temperature coolant supplied to the first heat-exchanger 72 by the operation of the blower-fan (not shown). Thereafter, the ambient air in the high-temperature state may be introduced into the vehicle interior, thereby achieving heating of the vehicle interior.

In other words, according to a heat pump system according to the present embodiment, for heating the vehicle interior, by absorbing the waste heat of the battery module 22 by the chiller 106 and using it to increase the temperature of the refrigerant, the power consumption of the compressor may be reduced and the heating efficiency may be improved.

The present embodiment has been described that, for heating the vehicle interior, the coolant whose temperature is increased at the condenser 102 may flow into the first heat-exchanger 72 along the fifth line 51 and the seventh line 71, but is not limited thereto.

In other words, when maximum heating of the vehicle interior is desired, the fifth line 51, the seventh line 71, and the eighth line 81 may be interconnected by the operation of the second valve module 4.

In such a state, when the third water pump 54 is operated, the coolant whose temperature is increased at the condenser 102 may be supplied to both of the first heat-exchanger 72 and the second heat-exchanger 82 while circulating along the fifth line 51, the seventh line 71, and the eighth line 81.

In addition, when dehumidification is desired while heating the vehicle interior, the expanded refrigerant may be supplied to the evaporator 104. The sixth line 61 may be connected to the eighth line 81 by the operation of the second valve module 4.

Accordingly, the sixth line 61 and the eighth line 81 may form one closed circuit through which the coolant circulates by the operation of the second valve module 4. Then, the coolant may circulate along the sixth line 61 and the eighth line 81 interconnected by the operation of the fourth water pump 64.

Accordingly, the low-temperature coolant cooled at the evaporator 104 may circulate along the sixth line 61 and the eighth line 81 by the operation of the fourth water pump 64 and second valve module 4, and thereby, be supplied to the second heat-exchanger 82.

Accordingly, the ambient air introduced into the vehicle interior may be dehumidified while having exchanged heat with the low-temperature coolant supplied to the second heat-exchanger 82 by the operation of the blower-fan (not shown).

Then, the dehumidified ambient air may be converted into the high-temperature state while passing through the first heat-exchanger 72 and then introduced into the vehicle interior, thereby smoothly heating and dehumidifying the vehicle interior.

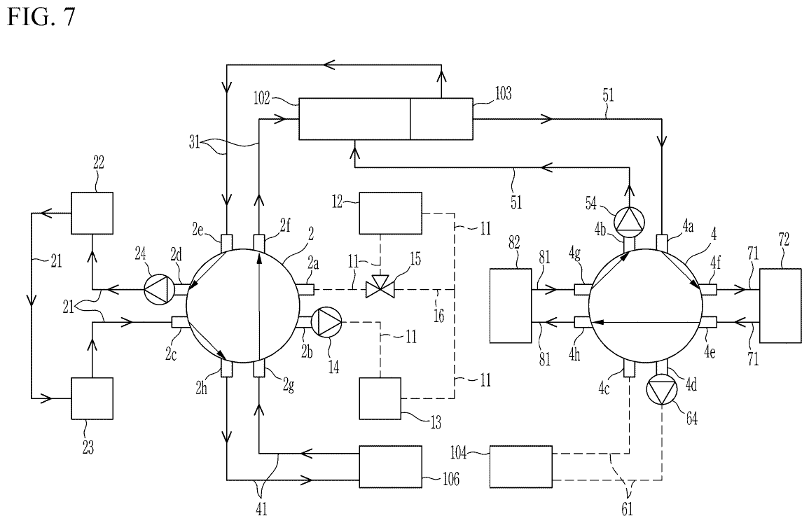

In addition, in a heat pump system for a vehicle according to an embodiment, the operation according to the sixth mode for heating the vehicle interior by using the electric heater 103 and recollecting the residual heat of the coolant while heating the battery module 22 is described with reference to FIG. 7.

FIG. 7 is an operation diagram according to the sixth mode in a heat pump system for a vehicle according to an embodiment.

Referring to FIG. 7, the refrigerant may circulate through the condenser 102 and the chiller 106. At this time, the refrigerant may not be supplied to the evaporator 104, and the expanded refrigerant may be supplied to the chiller 106.

the first line 11 may be closed by the operation of the first valve module 2. At the same time, the sixth line 61 may be closed by the operation of the second valve module 4.

In such a state, the second line 21, the third line 31, and the fourth line 41 may be interconnected by the operation of the first valve module 2 such that the coolant having passed through the condenser 102 and the electric heater 103 may sequentially pass through the battery module 22 and the chiller 106.

The second water pump 24 and the electric heater 103 may operate.

Accordingly, the coolant whose temperature is increased while passing through the electric heater 103 may be introduced into the third inlet port 2e of the first valve module 2 along the third line 31.

The coolant introduced into the third inlet port 2e of the first valve module 2 may be discharged to the second line 21 connected to the second outlet port 2d of the first valve module 2 by the operation of the first valve module 2.

The coolant discharged to the second line 21 may increase the temperature of the battery module 22 while passing through the battery module 22.

Then, the coolant having passed through the battery module 22 and the autonomous driving controller 23 may be introduced into the second inlet port 2c of the first valve module 2 along the second line 21.

The coolant introduced into the second inlet port 2c of the first valve module 2 may be discharged to the fourth line 41 connected to the fourth outlet port 2h of the first valve module 2 by the operation of the first valve module 2.

The coolant discharged to the fourth line 41 may be supplied to the chiller 106. At this time, the chiller 106 may increase the temperature of the refrigerant by using the residual heat remaining in the coolant having passed through the battery module 22.

In other words, the chiller 106 may be used to increase the temperature of the refrigerant by recollecting the residual heat of the coolant through heat-exchange between the coolant and the refrigerant.

The refrigerant evaporated at the chiller 106 may be introduced into the compressor, and the refrigerant compressed at the compressor may be supplied to the condenser 102. Accordingly, the refrigerant supplied to the condenser 102 may increase the temperature of the coolant while having exchanged heat with the coolant introduced via the third line 31.

The coolant having passed through the chiller 106 may be introduced into the fourth inlet port 2g of the first valve module 2 along the fourth line 41.

The coolant introduced into the fourth inlet port 2g of the first valve module 2 may be discharged to the third line 31 connected to the third outlet port 2f of the first valve module 2 by the operation of the first valve module 2.

The coolant discharged to the third line 31 may pass through the condenser 102 and the electric heater 103 and then flow back into the first valve module 2 along the third line 31, thereby repeatedly performing the above-described processes.

In other words, in the sixth mode, the second line 21, the third line 31, and the fourth line 41 may form one closed circuit through which the coolant circulates by the operation of the first valve module 2.

In such a state, the coolant may circulate along the second line 21, the third line 31, and the fourth line 41 that are interconnected by the operation of the second water pump 24.

Simultaneously, the fifth line 51 may be connected to the seventh line 71 and the eighth line 81 by the operation of the second valve module 4, such that the coolant whose temperature is increased while passing through the electric heater 103 may be introduced into the first heat-exchanger 72 and the second heat-exchanger 82.

Accordingly, the fifth line 51, the seventh line 71, and the eighth line 81 may form one closed circuit through which the coolant circulates by the operation of the second valve module 4. Then, the coolant may circulate along the fifth line 51, the seventh line 71, and the eighth line 81 that are interconnected by the operation of the third water pump 54.

In other words, the coolant discharged to the fifth line 51 through the first outlet port 4b of the second valve module 4 may pass through the condenser 102 and the electric heater 103.

At this time, the electric heater 103 may heat the introduced coolant. At the same time, the condenser 102 may heat the introduced coolant, together with the electric heater 103.

In other words, for increasing the temperature of the coolant, the electric heater 103 may perform a main role, and the condenser 102 may perform an auxiliary role. By such an operation, the temperature of the coolant may be increased.

The coolant whose temperature is increased may be introduced into the first inlet port 4a of the second valve module 4 along the fifth line 51. Thereafter, the coolant introduced into the first inlet port 4a of the second valve module 4 may be discharged to the seventh line 71 connected to the third outlet port 4f of the second valve module 4 by the operation of the second valve module 4.

The coolant discharged to the seventh line 71 may pass through the first heat-exchanger 72 and then may be introduced into the third inlet port 4e of the second valve module 4 along the seventh line 71.

In addition, the coolant introduced into the third inlet port 4e of the second valve module 4 may be discharged to the eighth line 81 connected to the fourth outlet port 4h of the second valve module 4 by the operation of the second valve module 4.

The coolant discharged to the eighth line 81 may pass through the second heat-exchanger 82 and then may be introduced into the fourth inlet port 4g of the second valve module 4 along the eighth line 81.

Then, the coolant introduced into the fourth inlet port 4g of the second valve module 4 may be discharged again to the first outlet port 4b of the second valve module 4 by the operation of the second valve module 4.

In other words, the coolant whose temperature is increased at the condenser 102 and the electric heater 103 through such an operation may be introduced into the first heat-exchanger 72 and the second heat-exchanger 82.

In such a state, the ambient air introduced into the vehicle interior may be converted into the high-temperature state while having exchanged heat with the high-temperature coolant supplied to the first heat-exchanger 72 and the second heat-exchanger 82 by the operation of the blower-fan (not shown). Thereafter, the ambient air in the high-temperature state may be introduced into the vehicle interior, thereby achieving heating of the vehicle interior.

In addition, the heat pump system may supply the coolant whose temperature is increased while passing through the electric heater 103 to the battery module 22 in order to heat the battery module 22, thereby efficiently increasing the temperature of the battery module 22.

In addition, the heat pump system may recollect the residual heat of the coolant having heated the battery module 22 by the chiller 106 and may minimize the usage of the electric heater 103 by using the condenser 102 as an auxiliary means for heating the coolant.

As described above, when a heat pump system for a vehicle according to an embodiment is applied, by selectively exchanging heat between the thermal energy generated from the refrigerant when condensing and evaporating the refrigerant and the coolant, and by adjusting a temperature of the vehicle interior by using the heat-exchanged low-temperature or the high-temperature coolant, the entire system may be streamlined and the layout of connection pipes through which the refrigerant circulates may be streamlined.

In addition, according to the present disclosure, for heating the vehicle interior, the heating efficiency of the vehicle may be improved by selectively using ambient air heat, waste heat of the electrical component 13, and waste heat of the battery module 22. The overall travel distance of the vehicle may be increased through efficient temperature adjustment of the battery module 22, such that the battery module 22 may exhibit optimal performance.

In addition, according to the present disclosure, when maximum cooling or heating is desired, by forming one independent closed circuit through which the coolant circulates the condenser or the evaporator and by supplying the same coolant, which may be of low temperature or high temperature, to the first heat-exchanger 72 and the second heat-exchanger 82, the cooling and heating performance of the vehicle interior may be improved.

In addition, according to the present disclosure, the temperature of the electrical component 13 and the battery module 22 may be efficiently adjusted by controlling the first valve module 2. As a result, the overall marketability of the vehicle may be improved.

In addition, according to the present disclosure, due to streamlining of the entire system, it is possible to reduce the overall manufacturing cost and weight. and to improve space utilization by minimizing the number of components.

While this disclosure has been described in connection with what is presently considered to be practical embodiments, it is to be understood that the disclosure is not limited to the disclosed embodiments. On the contrary, the disclosure is intended to cover various modifications and equivalent arrangements included within the spirit and scope of the appended claims.

### DESCRIPTION OF SYMBOLS

2, 4: first and second valve modules
11: first line
12: radiator
13: electrical component
14: first water pump
15: branch valve
16: branch line
21: second line
22: battery module
23: autonomous driving controller
24: second water pump
31: third line
41: fourth line
51: fifth line
54: third water pump
61: sixth line
64: fourth water pump
71: seventh line
72: first heat-exchanger
81: eighth line
82: second heat-exchanger
102: condenser
103: electric heater
104: evaporator
106: chiller

What is claimed is:

1. A heat pump system for a vehicle, comprising:
a first valve module having at least one inlet port and at least one outlet port;
a second valve module having at least one inlet port and at least one outlet port;
a first line having a first end and a second end connected to the first valve module to flow a coolant and provided with a radiator and an electrical component;
a second line having a first end and a second end connected to the first valve module to flow the coolant and provided with a battery module;
a third line having a first end and a second end connected to the first valve module to flow the coolant and provided with a condenser;
a fourth line having a first end and a second end connected to the first valve module to flow the coolant and provided with a chiller;
a fifth line having a first end and a second end connected to the second valve module to flow the coolant and connected to the condenser;
a sixth line having a first end and a second end connected to the second valve module to flow the coolant, and provided with an evaporator;
a seventh line having a first end and a second end connected to the second valve module to flow the coolant and provided with a first heat-exchanger; and
an eighth line having a first end and a second end connected to the second valve module to flow the coolant and provided with a second heat-exchanger,
wherein the first valve module and the second valve module are configured to selectively connect the first to eighth lines based on at least one mode for temperature adjustment of a vehicle interior and temperature adjustment of the battery module and to control a flowing movement of the coolant.

2. The heat pump system of claim 1, further comprising:
a branch valve provided on the first line between the first valve module and the radiator; and
a branch line having a first end connected to the branch valve, and a second end connected to the first line between the radiator and the electrical component.

3. The heat pump system of claim 2, wherein the at least one mode comprises:
a first mode for cooling the vehicle interior and cooling the electrical component and the battery module;
a second mode for heating the vehicle interior and recollecting ambient air heat and waste heat of the electrical component;
a third mode for heating the vehicle interior and recollecting waste heat of the electrical component and the battery module;
a fourth mode for heating the vehicle interior and heating the battery module while recollecting the waste heat of the electrical component;
a fifth mode for heating the vehicle interior and recollecting the waste heat of the battery module; and
a sixth mode for heating the vehicle interior by using an electric heater and recollecting residual heat of the coolant while heating the battery module.

4. The heat pump system of claim 3, wherein, in the first mode:
the first line is connected to the third line by an operation of the first valve module such that the coolant cooled at the radiator is supplied to the electrical component and the condenser;
the second line is connected to the fourth line by the operation of the first valve module such that the coolant having passed through the chiller is supplied to the battery module; and
the sixth line is connected to at least one of the seventh line and the eighth line by an operation of the second valve module, such that a low-temperature coolant having been cooled while passing through the evaporator is supplied to one or all of the first heat-exchanger and the second heat-exchanger.

5. The heat pump system of claim 3, wherein, in the second mode:
the first line is connected to the fourth line by an operation of the first valve module such that the coolant having passed through the radiator and the electrical component is supplied to the chiller;
the third line is closed by the operation of the first valve module; and
the fifth line is connected to at least one of the seventh line and the eighth line by an operation of the second valve module, such that the coolant whose temperature is increased while passing through the condenser is supplied to one or all of the first heat-exchanger and the second heat-exchanger.

6. The heat pump system of claim 3, wherein, in the third mode:
the first line, the second line, and the fourth line are interconnected by an operation of the first valve module such that the coolant having passed through the electrical component and the battery module is supplied to the chiller;
a partial first line connecting a second end of the branch line to the radiator is closed by an operation of the branch valve such that the coolant having passed through the electrical component is not supplied to the radiator;
the branch line is opened by the operation of the branch valve;
the third line is closed by the operation of the first valve module; and
the fifth line is connected to at least one of the seventh line and the eighth line by an operation of the second valve module, such that the coolant whose temperature is increased while passing through the condenser is supplied to one or all of the first heat-exchanger and the second heat-exchanger.

7. The heat pump system of claim 3, wherein, in the fourth mode:
the first line is connected to the fourth line by an operation of the first valve module such that the coolant having passed through the electrical component is supplied to the chiller;
a partial first line connecting a second end of the branch line to the radiator is closed by an operation of the branch valve such that the coolant having passed through the electrical component is not supplied to the radiator;
the branch line is opened by the operation of the branch valve;
the second line is connected to the third line by the operation of the first valve module such that the coolant having passed through the condenser is supplied to the battery module; and
the fifth line is connected to at least one of the seventh line and the eighth line by an operation of the second valve module, such that the coolant whose temperature is increased while passing through the condenser is supplied to one or all of the first heat-exchanger and the second heat-exchanger.

8. The heat pump system of claim 3, wherein, in the fifth mode:
the first line and the third line are closed by an operation of the first valve module;
the second line is connected to the fourth line by the operation of the first valve module such that the coolant having passed through the battery module is supplied to the chiller; and
the fifth line is connected to at least one of the seventh line and the eighth line by an operation of the second valve module, such that the coolant whose temperature is increased while passing through the condenser is supplied to one or all of the first heat-exchanger and the second heat-exchanger.

9. The heat pump system of claim 3, wherein, in the sixth mode:
the first line is closed by an operation of the first valve module;
the second line, the third line, and the fourth line are interconnected by the operation of the first valve module such that the coolant having passed through the condenser and the electric heater sequentially pass through the battery module and the chiller;
the electric heater is operated;
the fifth line is connected to the seventh line and the eighth line by an operation of the second valve module such that the coolant whose temperature is increased while passing through the electric heater is supplied to the first heat-exchanger and the second heat-exchanger;
the battery module increases its temperature by the coolant whose temperature is increased while passing through the electric heater; and
the chiller recollects a residual heat remaining in the coolant having passed through the battery module.

10. The heat pump system of claim 3, wherein, when dehumidification of the vehicle interior is desired in the first mode:
the fifth line is connected to the seventh line by an operation of the second valve module such that the coolant whose temperature is increased while passing through the condenser is supplied to the first heat-exchanger.

11. The heat pump system of claim 3, wherein, when dehumidification of the vehicle interior is desired in the second mode, the third mode, the fourth mode, and the fifth mode:
an expanded refrigerant is supplied to the evaporator; and
the sixth line is connected to the eighth line by an operation of the second valve module such that the coolant having been cooled while passing through the evaporator is supplied to the second heat-exchanger.

12. The heat pump system of claim 1, wherein the first valve module comprises:
a first inlet port connected to a first end of the first line;
a first outlet port connected to a second end of the first line;
a second inlet port connected to a first end of the second line;
a second outlet port connected to a second end of the second line;
a third inlet port connected to a first end of the third line;
a third outlet port connected to a second end of the third line;
a fourth inlet port connected to a first end of the fourth line; and
a fourth outlet port connected to the first end of the fourth line.

13. The heat pump system of claim 1, wherein the second valve module comprises:
a first inlet port connected to a first end of the fifth line;
a first outlet port connected to a second end of the fifth line;
a second inlet port connected to a first end of the sixth line;
a second outlet port connected to a second end of the sixth line;
a third inlet port connected to a first end of the seventh line;
a third outlet port connected to a second end of the seventh line;
a fourth inlet port connected to a first end of the eighth line; and
a fourth outlet port connected to a second end of the eighth line.

14. The heat pump system of claim 1, further comprising:
a first water pump provided on the first line;
a second water pump provided on the second line;
a third water pump provided on the fifth line; and
a fourth water pump provided on the sixth line.

15. The heat pump system of claim 1, wherein:
an electric heater is further provided at a downstream end of the condenser;
the third line is connected to the condenser and the electric heater such that the coolant sequentially passes through the condenser and the electric heater; and
the fifth line is connected to the condenser and the electric heater such that the coolant sequentially passes through the condenser and the electric heater.

16. The heat pump system of claim 15, wherein the electric heater is integrally formed with the condenser.

17. The heat pump system of claim 1, wherein an autonomous driving controller is provided on the second line.
